(19) United States
(12) Patent Application Publication
(10) Pub. No.: US 2026/0075152 A1
(43) Pub. Date: Mar. 12, 2026

(54) SCANNER EXCLUDING BLANK PAGE DATA FROM SCAN DATA BASED ON INFORMATION OUTPUTTED FROM TRAINED MACHINE LEARNING MODEL

(71) Applicant: BROTHER KOGYO KABUSHIKI KAISHA, Nagoya (JP)

(72) Inventor: Asahi MIZUKOSHI, Nagoya (JP)

(21) Appl. No.: 19/306,324

(22) Filed: Aug. 21, 2025

(30) Foreign Application Priority Data
Sep. 9, 2024 (JP) 2024-154682

(51) Int. Cl. H04N 1/00; H04N 1/04; H04N 1/32

(52) U.S. Cl. CPC H04N 1/00816; H04N 1/00244; H04N 1/00413; H04N 1/00803; H04N 1/0417; H04N 1/32475; H04N 2201/0094

(57) ABSTRACT

A controller of a scanner reads an original using a scanning engine to generate first scan data. The first scan data is for a plurality of page images each representing corresponding one or more sheets of a plurality of sheets in the original. The controller transmits scan-related information to a server. The scan-related information is related to page data for first target page images. The controller receives determination information from the server. The determination information indicates that one or more second target page images of the first target page images represent blank pages. The determination information is outputted by a trained machine learning model based on the scan-related information. The controller generates second scan data by excluding blank page data from the first scan data based on the determination information. The controller outputs the second scan data or an object based on the second scan data.

### REFERENCE TO RELATED APPLICATIONS

This application claims priority from Japanese Patent Application No. 2024-154682 filed on Sep. 9, 2024. The entire content of the priority application is incorporated herein by reference.

### BACKGROUND ART

Known are scanners that scan a document and determine whether any pages in the scanned document are blank. One such scanner is known to perform, for each page, both a blank page determination using a histogram and a blank page determination using edge detection, based on image data representing an image of the document and designates that page to be blank when both determinations indicate that the page is blank.

### SUMMARY

However, blank page determinations executed on a scanner can result in false determinations. Therefore, known technologies related to detecting blank pages in scanned results have room for improvement.

In order to attain the above and other objects, the present disclosure provides a scanner. The scanner includes a scanning engine, a user interface, a communication interface, and a controller. The controller includes one or more processors. The controller is configured to perform: a scan process under a scan start condition including a requirement that a scan instruction is received through the user interface, the scan process including: reading an original using the scanning engine to generate first scan data, the original including a plurality of sheets, the first scan data for a plurality of page images each representing corresponding one or more sheets of the plurality of sheets; a transmission process under a transmission condition, the transmission process including: transmitting scan-related information to a server through the communication interface, the scan-related information being target page data in the first scan data or data based on the target page data, the target page data being page data for one or more first target page images of the plurality of page images; a determination receiving process under a receiving condition including a requirement that the transmission process is completed, the determination receiving process including: receiving determination information from the server via the communication interface, the determination information indicating that one or more second target page images of the one or more first target page images represent blank pages, the determination information being outputted by a trained machine learning model based on the scan-related information; and a first outputting process under a first outputting condition, the first outputting condition including a requirement that the determination information is received from the server through the communication interface, the first outputting process including: generating second scan data by excluding first blank page data from the first scan data based on the determination information, the first blank page data being page data for one or more removal page images of the one or more second target page images; and outputting a first output object, the first output object being the second scan data or an object based on the second scan data.

In the above structure, blank page data is extracted from the scan data based on the determination information. Accordingly, the blank page data can be determined appropriately.

### BRIEF DESCRIPTION OF DRAWINGS

FIG. 1 is an illustration of a configuration of a multifunction peripheral.

FIG. 2 is a flowchart illustrating an AI scanning process.

FIG. 3 is a flowchart illustrating a blank page extraction process.

FIG. 4 is a flowchart illustrating a single-page determination process.

FIGS. 5A and 5B are examples of histograms.

FIG. 6 is an illustration of a confirmation screen.

FIG. 7 is a flowchart illustrating a single-page determination process.

FIGS. 8A and 8B are examples of histograms.

FIG. 9 is a flowchart illustrating a single-page determination process.

FIG. 10 is a flowchart illustrating a blank page extraction process.

FIG. 11 is a table illustrating thresholds sets.

### DESCRIPTION

Below, a first embodiment of a scanner according to the present disclosure will be described while referring to the accompanying drawings. In this specification, the scanner of the present disclosure is applied to a multifunction peripheral (hereinafter “MFP”) having various functions, including an image-reading function and a communication function.

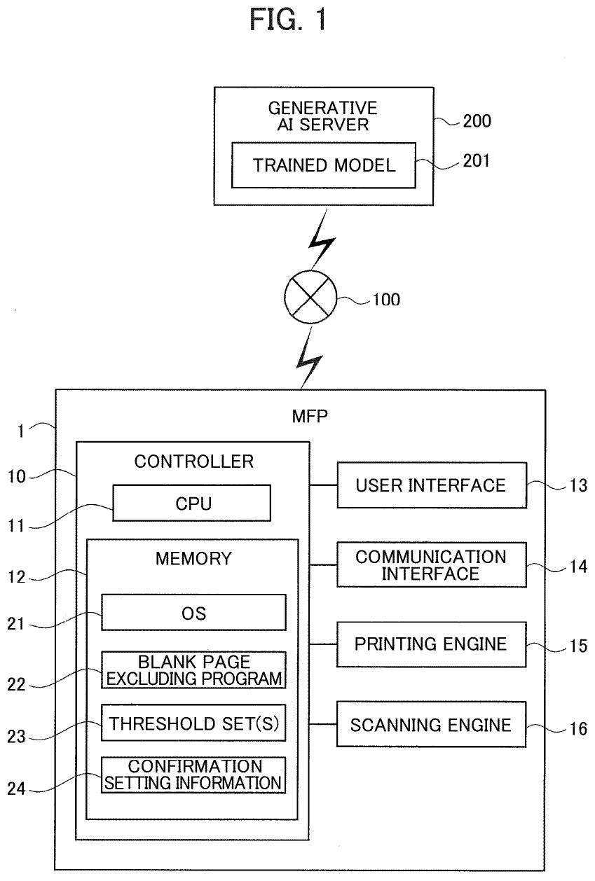

FIG. 1 shows an example of an MFP 1 according to the present embodiment. The MFP 1 includes a controller 10. The controller 10 includes a CPU 11 and a memory 12. The MFP 1 includes a user interface 13, a communication interface 14, a printing engine 15, and a scanning engine 16, all of which are electrically connected to the controller 10. Note that the controller 10 in FIG. 1 is a general concept that covers all hardware and software used for controlling the MFP 1 and is not limited to representing a single piece of hardware actually present in the MFP 1. The MFP 1 is an example of a scanner.

The CPU 11 of the MFP 1 executes various processes according to programs read from the memory 12 or based on user operations. The memory 12 of the MFP 1 stores various programs and data, including an operating system (hereinafter “OS”) 21 and a blank page excluding program 22, a threshold set 23, and confirmation setting information 24. The memory 12 is used as a work area when executing various processes. A buffer included in the CPU 11 is an example of the memory 12. The programs and data will be described later in greater detail.

Examples of the memory 12 may include ROM, RAM, or a hard disk drive built into the MFP 1, or may be a storage medium that is readable and writable by the CPU 11. A USB memory connected to the MFP 1, an external memory such as a hard disk drive, and a memory or hard disk drive included in a device connected to the MFP 1 via the communication interface 14 are all examples of memory 12.

A computer-readable storage medium is a non-transitory medium. Non-transitory media include CD-ROM and DVD-ROM. A non-transitory medium is also a tangible medium. On the other hand, electric signals that convey programs downloaded from a device on the Internet such as a server are a computer-readable signal medium, which is one type of computer-readable medium but is not a non-transitory computer-readable storage medium.

The user interface 13 includes a touchscreen, for example. The touchscreen includes hardware that displays screens for reporting information to the user, and hardware that receives user operations. The user interface 13 may include a combination of a display and hardware buttons.

The communication interface 14 includes hardware for communicating with external devices. The communication interface 14 includes functions supporting such communication standards as Wi-Fi (U.S. trademark of Wi-Fi Alliance CORPORATION), Ethernet, and Universal Serial Bus (USB). The MFP 1 may also include a plurality of communication interfaces 14 supporting a plurality of communication standards.

The printing engine 15 includes configurations for printing images on sheets or other print media. The method of image formation used by the printing engine 15 may be the electrophotographic method or the inkjet method, for example. The printing engine 15 may be configured to be capable of multicolor printing or may be configured to be capable of only single-color printing.

The scanning engine 16 includes a configuration for scanning a document placed on a flatbed or a document set in a document feeder and conveyed to a reading position, and for generating scan data as the scanning results, and output an object based on the generated scan data. In the present embodiment, the MFP 1 may include the scanning engine 16 that can perform color scanning in which the document is read as a color image. The MFP 1 may include the scanning engine 16 that can perform only monochrome scanning in which the document is read as a monochrome image.

As shown in FIG. 1, the MFP 1 can connect to an internet 100 via the communication interface 14 and can access a generative AI server 200, for example. The generative AI server 200 includes a trained model 201. The trained model 201 is a trained machine learning model which has been pre-trained using various types of data to output response data based on the input data. The generative AI server 200 may be a dedicated server prepared by the vendor or manufacturer of the MFP 1. The generative AI server 200 may be a server made available on the internet 100 by an AI company. One example of an AI company is OpenAI. The generative AI server 200 is an example of the server using the trained machine learning model.

The trained model 201 has been trained on image information classified as both blank and not blank and can output determination information indicating whether an image is blank or not blank based on inputted data. The image information used for learning can be image data such as scan data or data such as histograms showing the distribution of luminance levels. Trained models on servers prepared by AI companies may have learned image information classified as either blank or not blank using big data. Therefore, the trained model can be expected to be capable of analyzing inputted data and determining with high accuracy whether an image represented by the data is a blank image or not a blank image. The trained model 201 may also be a model prepared by the vendor or manufacture of the MFP 1.

The generative AI server 200 may include an application programming interface (API) for instructing the trained model 201 to output determination information indicating whether a page is blank or not blank. The MFP 1 may be capable of instructing the trained model 201 to output determination information specifying blank or not blank by using the API included in the generative AI server 200 for instructing the trained model 201 to output determination information specifying blank or not blank.

Alternatively, the generative AI server 200 may accept instructions in the form of a prompt, i.e., in the form of a character string. For example, the MFP 1 may be capable of instructing the trained model 201 to output determination information specifying blank or not blank by inputting input data into the generative AI server 200 together with a prompt instructing the generative AI server 200 to output determination information specifying whether the inputted data represents a blank page or a non-blank page.

A procedure to output an object based on the scan data while excluding blank pages will be described next. In the following description, actions such as “determine,” “extract,” “select,” “calculate,” “set,” “identify,” “acquire,” “obtain,” “receive,” “control,” “set,” represent processes performed by the CPU 11. Processes performed by the CPU 11 include processes that control hardware using APIs included in an operating system (OS). In the description, an operation of each program is described without referring to the OS. For example, expressions, such as “program B controls hardware C” may indicate “program B controls hardware C by using an API included in the OS”. Further, processes performed by the CPU 11 according to instructions described in a program may be described in abbreviated terms, such as “the CPU 11 executes” or “the program executes.”

In the description, the terms “notice”, “notification”, “report”, “reply”, “response”, and “answer” are used not only to refer to communication directed to a person, but also refer to communication between devices or information transmission or reception between devices.

Note that the term “acquire” in this specification is used as a concept that does not necessarily require a request. In other words, a process by which the CPU 11 receives data without requesting that data is included in the concept of “the CPU 11 acquires data.” This holds true for the term “obtain.” The term “data” described herein is expressed as bit strings that can be read by a computer. Data of different formats are treated as the same data when the content of the data is essentially the same. The same holds true for “information” in this specification. An “instruction,” and a “request,” is processed by outputting information indicating the “instruction,” and the “request.” The terms “instruction” and “request” may also be used to describe information indicating an “instruction,” and a “request.”

Further, a process performed by the CPU 11 to determine whether information A indicates circumstance B may be described conceptually as “determining whether circumstance B based on information A.” A process in which the CPU 11 determines whether information A indicates circumstance B or circumstance C may be described conceptually as “determining whether circumstance B or circumstance C based on information A.”

In this specification, a setting item may simply be referred to as a “setting.” Setting values may be referred to simply as “settings.” The term “variable” refers to a container holding a value, which may be referenced or modified during execution of processing. The term “value” or “setting value” refers to specific data assigned to a variable or parameter. The term “parameter” refers to a variable element that receives input or to the value assigned to such an element, depending on the context. A parameter is used as a configurable element that influences processing conditions or behaviors. The term “setting item” refers to a representation, identifier, or name of a variable or parameter.

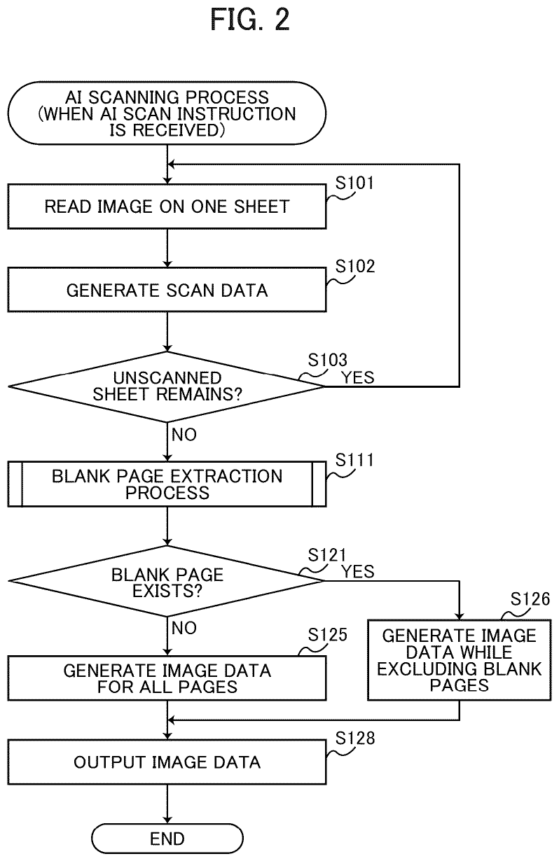

Next, steps in an AI scanning process according to the first embodiment will be described with reference to the flowchart in FIG. 2. The MFP 1 uses the scanning engine 16 to read a document and generate scan data when a scan instruction is received through an operation on the user interface 13 and performs output based on the generated scan data. The MFP 1 is also configured to exclude blank pages, i.e., to not perform output based on blank page scan data generated by reading blank pages of a document.

For excluding blank pages, the MFP 1 can use the trained model 201 of the generative AI server 200 to determine whether a page is a blank page that is subject to exclusion. The CPU 11 of the MFP 1 executes this AI scanning process to exclude blank pages using the generative AI server 200. The MFP 1 receives an operation for issuing an AI scan instruction prior to the AI scanning process. The AI scan instruction instructs the MFP 1 to execute the AI scanning process. The MFP 1 also accepts various types of instructions in addition to AI scan instructions and can execute various processes based on the received instructions. The AI scan instruction is an example of a specific scan instruction.

Conceptually, operations for issuing a scan instruction may include an operation for issuing a copy instruction. When an operation for issuing a copy instruction is received, the MFP 1 executes a print based on the generated scan data as the output process. The MFP 1 may also perform a similar process when an operation for issuing a scan instruction is received from an external device, such as a personal computer or a smartphone.

In S101 of the AI scanning process, the CPU 11 uses the scanning engine 16 to read the image on one sheet of the document. When the document placed in the document feeder includes a plurality of sheets, for example, the CPU 11 first conveys one sheet of the document and reads the image on that sheet. In S102 the CPU 11 generates image data of one sheet based on the reading results. In this example, when the scan data of the document including a plurality of sheets is generated, an image dataset obtained by reading a single sheet corresponds to one page of scan data. However, the CPU 11 may combine multiple image datasets obtained by reading multiple sheets and set the combined data as one page of scan data. The series of processes of S101 and S102 is an example of the scan process.

The CPU 11 temporarily stores generated scan data by associating a sequential page number with each page in the order they have been scanned. When double-sided scanning is performed, the CPU 11 generates one page worth of scan data from the reading results for each side of the sheet. The CPU 11 repeats S101 and S102 while sheets of the document still remain in the document feeder (S103: YES) or until the CPU 11 receives an instruction to terminate scanning, for example.

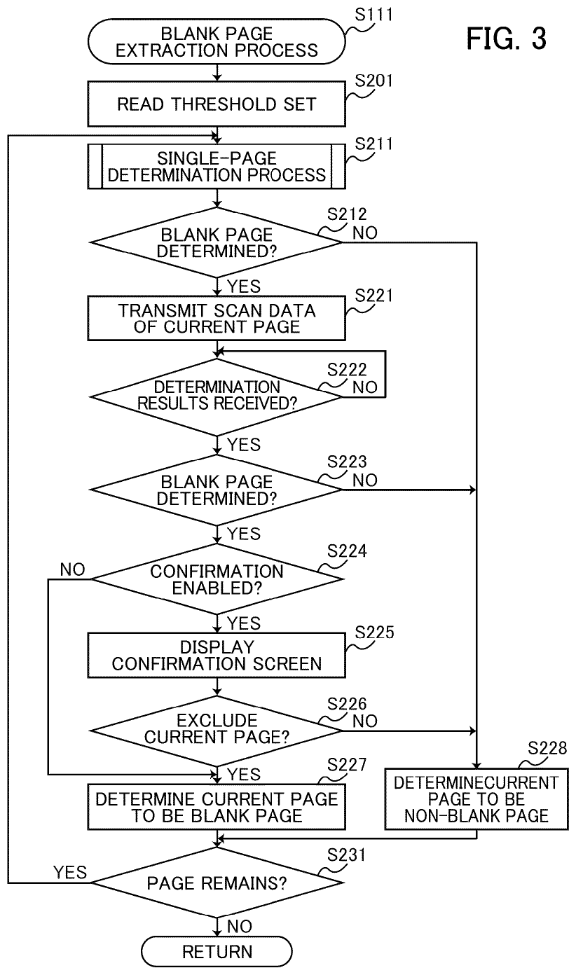

Once the CPU 11 has read all sheets (or all pages) of the document and has generated scan data for each (S103: NO), in S111 the CPU 11 executes a blank page extraction process. Steps in the blank page extraction process will be described with reference to the flowchart in FIG. 3.

In S201 of FIG. 3, the CPU 11 reads the threshold set 23 stored in the memory 12 (see FIG. 1). The threshold set 23 is a set of threshold values that the CPU 11 uses to determine whether a page is blank or not blank based on the scan data for that page. The threshold set 23 in this embodiment includes a range threshold value Thb, a modal percentage threshold value Thq, and a block threshold value Thr. These threshold values will be described later in detail. The memory 12 may include a plurality of threshold sets 23 and one of the plurality of threshold sets may be selected as a threshold set to be read in S201. In this case, the threshold set may be selected based on a user operation through the user interface 13.

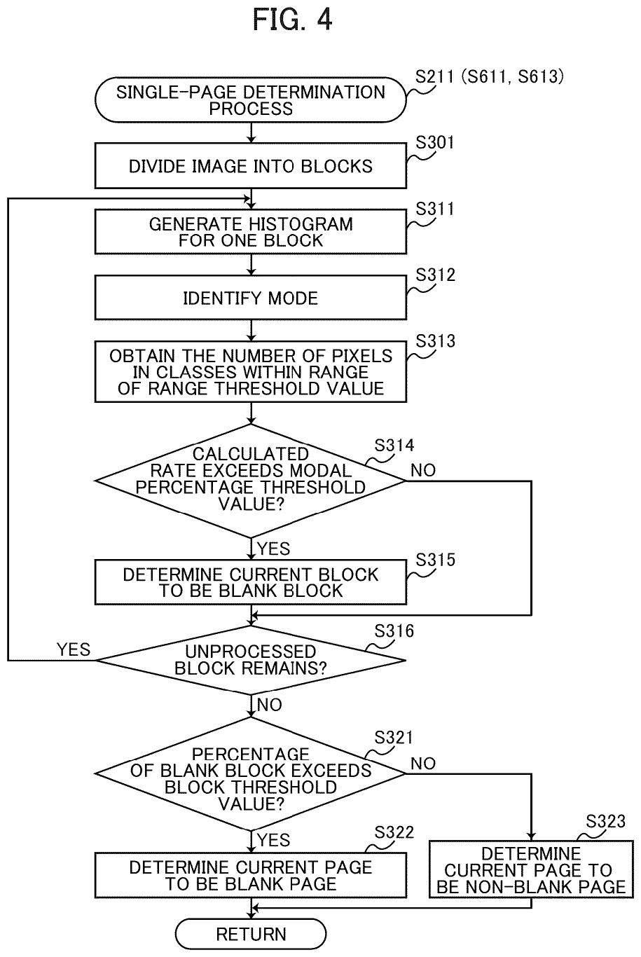

Next, in S211 the CPU 11 executes a single-page determination process on one page worth of the scan data generated in S102 of the AI scanning process using the threshold set 23 read in S201. Steps in the single-page determination process will be described here with reference to the flowchart in FIG. 4. The single-page determination process is a process to determine whether a target page is a blank page or not blank page. Here, the target page is selected from all the pages (all the sheets) of the document. The single-page determination process is an example of the in-device determination process.

In S301 of the single-page determination process, the CPU 11 divides the scan data for which a determination is to be made into blocks of a predetermined size. That is, the CPU 11 segments a region of an image based on the scan data for the current page (target page) into blocks each having a predetermined size. For example, the CPU 11 divides scan data read at 300 dpi into blocks of 18 pixels×18 pixels each. Thus, scan data generated by scanning an A4-size document sheet, for example, is divided into approximately 26,900 blocks.

Once the scan data has been divided into blocks, in S311 the CPU 11 generates a histogram for a block in which the class represents luminance and the frequency corresponds to the number of pixels. For example, the CPU 11 sorts the luminance value of each pixel into one of 64 classes (64 luminance levels) based on the scan data and obtains the number of pixels corresponding to each class. Based on this histogram, in S312 the CPU 11 identifies the mode M of the luminance levels, i.e., the class containing the largest number of pixels.

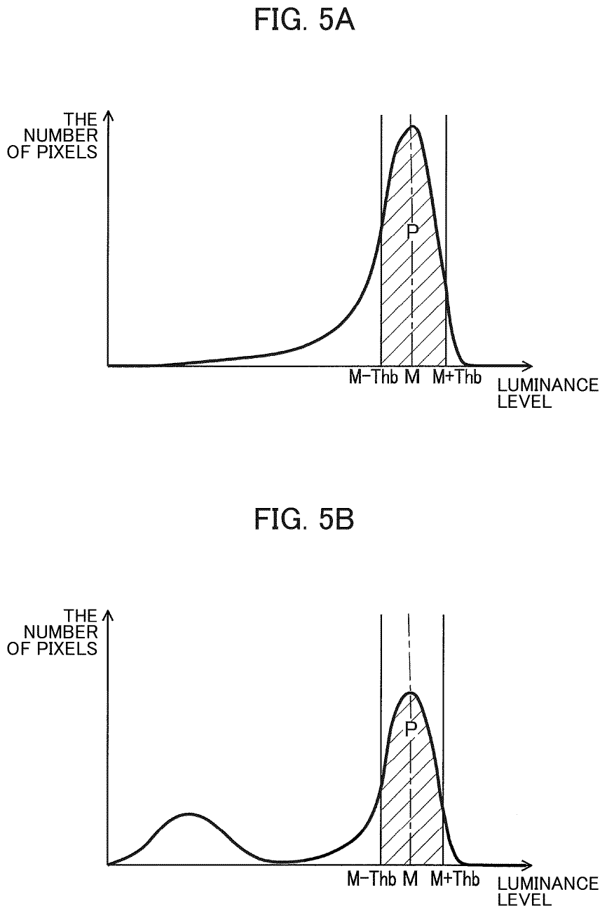

In S313 the CPU 11 obtains the number of pixels in classes within a range based on both the mode M and the range threshold value Thb. Here, the range threshold value Thb is included in the threshold set 23 read in S201 of the blank page extraction process. Specifically, the CPU 11 obtains the number of pixels in the classes within the range of the range threshold value Thb from the mode M. In other words, the CPU 11 obtains a total pixel number P of pixels included in the range from class (M-Thb) to class (M+Thb), as depicted by shading lines in FIG. 5A. When the value range of the histogram is divided into 64 classes of luminance levels, the range threshold value Thb is 12, for example. The range from class (M−Thb) to class (M+Thb) is an example of the specific range. The range threshold value Thb is used to determine the size of the specific range.

In S314 the CPU 11 determines whether the ratio of the total pixel number P obtained in S313 to the total number of pixels in one block exceeds the modal percentage threshold value Thq included in the threshold set 23. The modal percentage threshold value Thq may be 90%, for example. When one block has 18 pixels×18 pixels for a total of 324 pixels, then 90% of 324 is 291.6. Accordingly, the CPU 11 reaches a YES determination in S314 when the total pixel number P is greater than or equal to 292 pixels. The modal percentage threshold value Thq is an example of the threshold value.

Based on the determination results in S314, the CPU 11 determines whether the block contains printed matter. Or, in S314, the CPU 11 determines whether the block contains a non-blank image (an image represent some content). When many pixels have luminance values falling within luminance levels near the mode M, as in the example of FIG. 5A, the CPU 11 determines that the percentage of the total pixel number P exceeds the modal percentage threshold value Thq (S314: YES). Accordingly, in S315 the CPU 11 determines that this block is a blank block, i.e., a block having no printed matter. On the other hand, when many pixels have luminance values falling within luminance levels not near the mode M, as in the example of FIG. 5B, the CPU 11 determines that the percentage of the total pixel number P does not exceed the modal percentage threshold value Thq (S314: NO). Thus, the CPU 11 determines that this block contains printed matter and is not a blank block.

After the process of S315 or when the CPU 11 determines the block is not a blank block (S314: YES), in S316 the CPU 11 determines whether there remain any blocks that have not undergone the determination of being a blank block or a non-blank block. When any unprocessed blocks remain (S316: YES), the CPU 11 returns to S311 and performs the same determination on the next block. The CPU 11 executes the process in S311-S315 for each block until determinations have been made for all blocks.

When the CPU 11 determines that the determination regarding whether the block is a blank block or a non-blank block has been completed for all blocks (S316: NO), in S321 the CPU 11 determines whether the percentage (or, ratio) of the number of blocks determined as blank blocks to the total number of blocks in one page exceeds the block threshold value Thr included in the threshold set 23. The block threshold value Thr may be 93.60%, for example. The block threshold value Thr is an example of the threshold value.

When the CPU 11 determines that the percentage of blank blocks exceeds the block threshold value Thr (S321: YES), in S322 the CPU 11 determines that the current page is a blank page. On the other hand, when the percentage of blank blocks does not exceed the block threshold value Thr (S321: NO), in S323 the CPU 11 determines that the current page is a non-blank page. Following S322 or S323, the CPU 11 ends the single-page determination process and returns to the blank page extraction process in FIG. 3.

The likelihood that a sheet will be determined to be blank in the single-page determination process differs depending on the threshold values in the threshold set 23. For example, a threshold set 23 having a range threshold value Thb of 12, a modal percentage threshold value Thq of 90%, and a block threshold value Thr of 93.60% may be applied when the scanned document contains a high content of non-white fibers, such as fibers of recycled paper, or the scanned document is susceptible to show-through due to use of a thin paper. By applying this threshold set 23, the CPU 11 is likely to determine that unprinted blocks containing fibers, and unprinted blocks exhibiting show-through are blank blocks. On the other hand, it is highly likely that when applying this threshold set 23, blocks with areas printed in light colors will also be identified as blank blocks. In other words, when this threshold set 23 is applied, it is highly likely that sheets of documents having areas printed in light colors will be determined to be blank, which is problematic.

In contrast, a threshold set 23 having a range threshold value Thb of 4, a modal percentage threshold value Thq of 90%, and a block threshold value Thr of 99.99% may be applied to printed matter with light-colored printed areas. By applying this threshold set 23, the CPU 11 is likely to determine that a block with printed areas, even of a light color, is not a blank block. On the other hand, by applying this threshold set 23, the CPU 11 is more likely to determine that unprinted blocks containing fibers of a paper, and unprinted blocks exhibiting show-through are not blank blocks. In other words, when this threshold set 23 is applied, it is highly likely that even unprinted pages of a document could be determined not to be blank, which is also problematic.

Thus, the likelihood that the MFP 1 will determine a document is blank differs according to the threshold settings. However, it is difficult for the user of the MFP 1 to select threshold values that yield suitable results for the scanned document.

Each threshold value included in the threshold set 23 may be a fixed value or a variable value set through a user operation. The MFP 1 may be able to accept a user selection from among threshold values that are more likely to determine a sheet is blank and threshold values that are less likely to determine a sheet is blank. When the threshold values are variable, the MFP 1 may have a predetermined range of possible values for each threshold value, for example.

Returning to the description of the blank page extraction process in FIG. 3, in S212 the CPU 11 determines whether the current page has been determined to be blank in the single-page determination process of S211. When the CPU 11 determines that the current page has been determined to be blank (S212: YES), in S221 the CPU 11 transmits scan data of the current page to the generative AI server 200 and requests that the generative AI server 200 return information indicating the determination results by the trained model 201 as to whether the current page is blank. The process of S221 is an example of the transmission process. For example, in this example, the threshold set 23 used in S211 is configured as a threshold set having threshold values that are more likely to yield a blank page determination. However, the CPU 11 uses a determination indicating that the current page is blank made in S211 as a tentative determination, and requests the trained model 201 to perform the determination regarding whether the current page is blank. The CPU 11 makes a final determination considering the response form the trained model 201.

That is, the CPU 11 instructs the generative AI server 200 to have the trained model 201 analyze the scan data and determine when the current page is a blank page and to return a response with the determination result. The CPU 11 may issue instructions by sending the scan data to the generative AI server 200 via a dedicated API or may issue instructions with a prompt. The scan data that the MFP 1 sends to the generative AI server 200 may be raw data, i.e., unaltered data from the scanning results obtained by the scanning engine 16, or may be processed data that has undergone one or more processes such as a format conversion on the MFP 1. Instead of the scan data, the CPU 11 may send the histogram for each block generated in S311 of the single-page determination process with instructions to determine, based on the histograms, whether the current page is blank and to return the determination result in a response.

The generative AI server 200 may also perform various processes on the scan data received from the MFP 1 prior to inputting the data into the trained model 201 to the extent that the data content is not significantly altered. In this specification, inputting scan data sent from the MFP 1 into the trained model 201 after performing various processes falls within the concept of the MFP 1 inputting the scan data into the trained model 201.

After sending the scan data to the generative AI server 200 in S221, the CPU 11 waits while information specifying the determination results have not been received from the generative AI server 200 (S222: NO). Once information is received from the generative AI server 200 (S222: YES), in S223 the CPU 11 determines whether the information received from the generative AI server 200 indicates that the current page has been determined to be blank. The trained model 201 of the generative AI server 200 is likely to perform the blank page determination with a different algorithm from that of the MFP 1. Therefore, the information received from the generative AI server 200 is likely to contain a highly accurate determination result that may differ from that of the MFP 1.

As with the inputted data, the generative AI server 200 may perform various processes on data outputted from the trained model 201 before transmitting the data to the MFP 1 to the extent that the content of the data is not significantly altered. In this specification, the MFP 1 receiving data that has undergone various processes after being outputted from the trained model 201 falls within the concept of the MFP 1 receiving data outputted from the trained model.

When the CPU 11 determines that the determination information received from the generative AI server 200 indicates that a blank page has been determined (S223: YES), in S224 the CPU 11 determines whether a setting has been configured to perform user confirmation. For example, the MFP 1 may be configured to accept a setting indicating whether to confirm with the user the results of blank page determinations by the trained model 201 when receiving an AI scan instruction. The MFP 1 then stores confirmation setting information 24 (see FIG. 1) representing the received setting in the memory 12. In other words, the confirmation setting information 24 is setting information indicating whether the confirmation is enabled or disabled.

When the CPU 11 determines based on the confirmation setting information 24 indicating that confirmation is enabled (S224: YES), in S225 the CPU 11 displays a confirmation screen on the user interface 13 and accepts a user selection. The CPU 11 asks the user whether the current page determined to be blank by the trained model 201 should be excluded from the scan data to be outputted. The process of S225 is an example of the confirmation process.

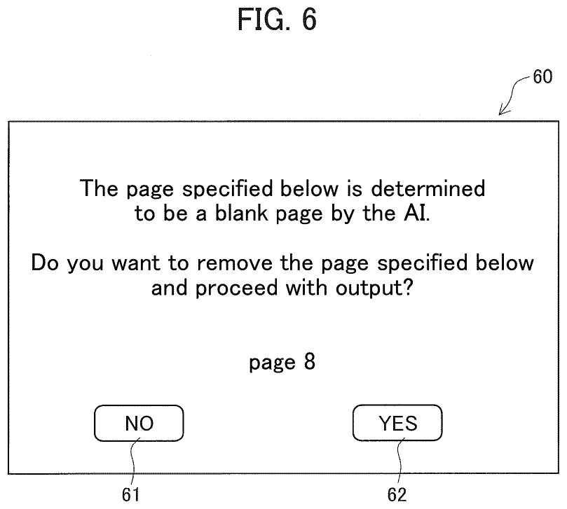

For example, the CPU 11 displays a confirmation screen 60 shown in FIG. 6. The confirmation screen 60 represents a message “The page specified below is determined to be a blank page by the AI” and a message “Do you want to remove the page specified below and proceed with output”. Here, “the page specified below” in the messages indicates the current page and, in this example, page 8. In other words, the confirmation screen 60 includes information indicating that the current page has been determined to be blank, a message asking whether to exclude the current page from the output, and two buttons 61 and 62 for receiving instructions from the user. The “No” button 61 displayed in the confirmation screen 60 receives an instruction not to exclude the current page from the output, while the “YES” button 62 receives an instruction to exclude the current page from the output. The CPU 11 then accepts a user operation on either the “No” button 61 or “YES” button 62. Note that the various buttons may also be called “icons.”

In S226 the CPU 11 determines whether an instruction to exclude the current page has been received. When the CPU 11 determines that an instruction to exclude the page has been received through an operation on the “YES” button 62 (S226: YES) or when the current CPU 11 determines in S224 that the confirmation requirement has not be enabled (S224: NO), in S227 the CPU 11 determines that the current page is a blank page.

On the other hand, when the CPU 11 determines in S212 that the current page has not been determined to be a blank page in the single-page determination process of S211 but rather is a non-blank page (S212: NO) or when the CPU 11 determines in S223 that the determination information received from the generative AI server 200 contains a determination that the current page is not blank (S223: NO) or when the CPU 11 determines in S226 that an instruction not to exclude the current page has been received through an operation on the “No” button 61 (S226: NO), in S228 the CPU 11 determines that the current page is a non-blank page.

In other words, the CPU 11 determines that the current page is a non-blank page when the generative AI server 200 has determined that the current page is not blank, even when the current page has been determined to be blank in the single-page determination process performed on the MFP 1 in S211. Further, even when the current page has been determined to be blank in the single-page determination process and also has been determined to be blank by the generative AI server 200, the CPU 11 can still change this determination result from the single-page determination process, and determine that the current page is a non-blank page based on the results of the user confirmation.

On the other hand, when the CPU 11 has determined in the single-page determination process that the current page is not blank, the CPU 11 determines that the current page is a non-blank page without transmitting scan data for the current page to the generative AI server 200. When the MFP 1 uses threshold values that are more inclined to yield a blank page determination in the single-page determination process of S211, for example, it is highly likely that a page determined to be not blank in the single-page determination process is in fact not blank. Since the CPU 11 executes the single-page determination process itself after performing a scan and prior to sending data to the generative AI server 200 and does not send scan data to the generative AI server 200 for pages that are determined to be not blank in the single-page determination process, the CPU 11 can avoid increasing the communication load.

The MFP 1 displays the confirmation screen 60 in S225 to confirm with the user whether to exclude a page that has been determined by the trained model 201 to be blank. That is, the confirmation screen 60 enables the user of the MFP 1 to restrict any pages determined to be blank by the trained model 201 from being excluded from the output when the user has concerns about the accuracy of the trained model 201 in making blank page determinations. By prompting the user to confirm only those pages determined to be blank by the trained model 201, the MFP 1 ensures that the amount of effort the user will exert is smaller than that in a conceivable case where the MFP 1 prompts the user to confirm all pages.

Moreover, users who feel that confirmation is tedious can disable the confirmation option. In this way, the MFP 1 can apply the determination made by the trained model 201 without displaying a confirmation screen or prompting the user to operate any buttons, making the process more user-friendly.

Following S227 or S228, in S231 the CPU 11 determines whether there remain other pages that have not undergone the blank page determination. When the CPU 11 determines that there remain other pages that have not undergone this process (S231: YES), the CPU 11 returns to S211 and performs the above determination on the next page. Once the CPU 11 determines that the process has been completed for all pages (S231: NO), the CPU 11 ends the blank page extraction process and returns to the AI scanning process in FIG. 2.

When the CPU 11 determines that a predetermined time period has elapsed after sending the scan data in S221 without receiving information from the generative AI server 200 or that the information received from the generative AI server 200 is indefinite or otherwise information that does not specify a determination result, the CPU 11 may apply the determination result from S211 or may assume that a determination is impossible and ask for confirmation from the user. Further, after transmitting the scan data in S221 or displaying the confirmation screen 60 in S225, the CPU 11 may begin processing the next page in parallel, without waiting to receive a determination result from the generative AI server 200 or a user operation.

Returning to the AI scanning process in FIG. 2, in S121 the CPU 11 determines whether any page determined to be blank page in the blank page extraction process of S111 exist. When the CPU 11 determines that no pages have been determined to be blank pages (S121: NO), in S125 the CPU 11 generates image data for all pages of the document based on the scan data for all pages. The image data is data for output and may be data based on the scan data, such as data obtained by converting the file format of the scan data. The CPU 11 may also use the unaltered scan data as the image data for output.

On the other hand, when the CPU 11 determines that one or more pages determined to be blank (S121: YES), in S126 the CPU 11 excludes the pages determined to be blank pages from the scan data in the scanning results and generates image data based on the scan data for pages other than the pages found to be blank. The CPU 11 may also use the unaltered scan data for the pages other than pages determined to be blank pages as the image data for output. Pages determined to be blank pages in the blank page extraction process of S111 are highly likely to be blank since they have been determined to be blank in S322 of the single-page determination process performed on the MFP 1 (see FIG. 4) and have been further determined to be blank by the trained model 201 of the generative AI server 200.

Following S125 or S126, in S128 the CPU 11 outputs the generated image data to the output destination specified in the scan settings and subsequently ends the AI scanning process. When the AI scan instruction received at the beginning of the AI scanning process is a copy instruction, for example, the CPU 11 uses the printing engine 15 to execute a print based on the image data. When the AI scan instruction received at the start of the process is an instruction to save the scanning results at a save location, the CPU 11 saves the generated image data at the save location. The save location may be designated by the user.

Examples of save locations for image data are the memory 12 of the MFP 1, a USB memory mounted in the MFP 1, an information processing device connected to the MFP 1, an email recipient specified by an email address registered on the MFP 1, and cloud storage to which the MFP 1 can upload data. The MFP 1 may also be configured to accept a file format designation for the image data being saved. Examples of file formats are JPEG, PDF, TIFF, and raw. When the MFP 1 receives a file format designation, the MFP 1 converts the scan data to the designated file format and saves the converted scan data at the designated save location. Allowing such designations for save location and file format can facilitate the user in using the saved image data.

The single-page determination process (S211 in FIG. 3) executed in the blank page extraction process of S111 in FIG. 2 may be any process in which the MFP 1 determines whether a page is blank and may not follow the steps shown in FIG. 4. For example, the CPU 11 may determine whether a page is blank using a histogram for one page, or by using the number of edges in each of a plurality of blocks making up the page. These methods will be described below.

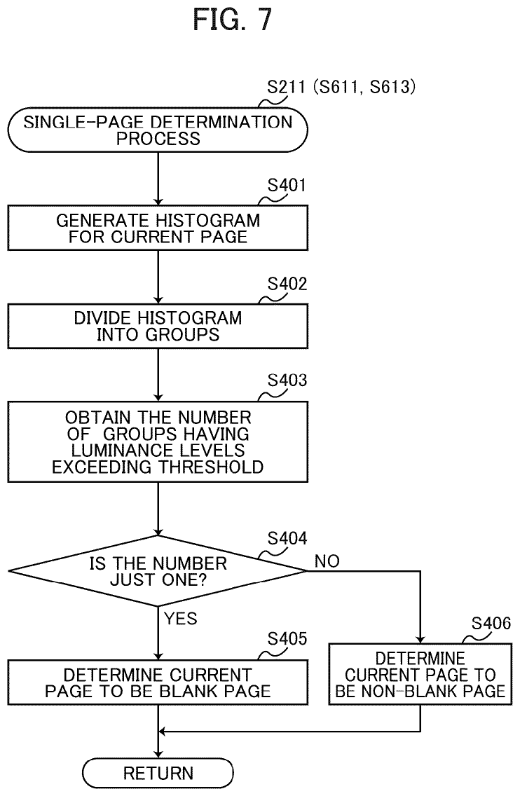

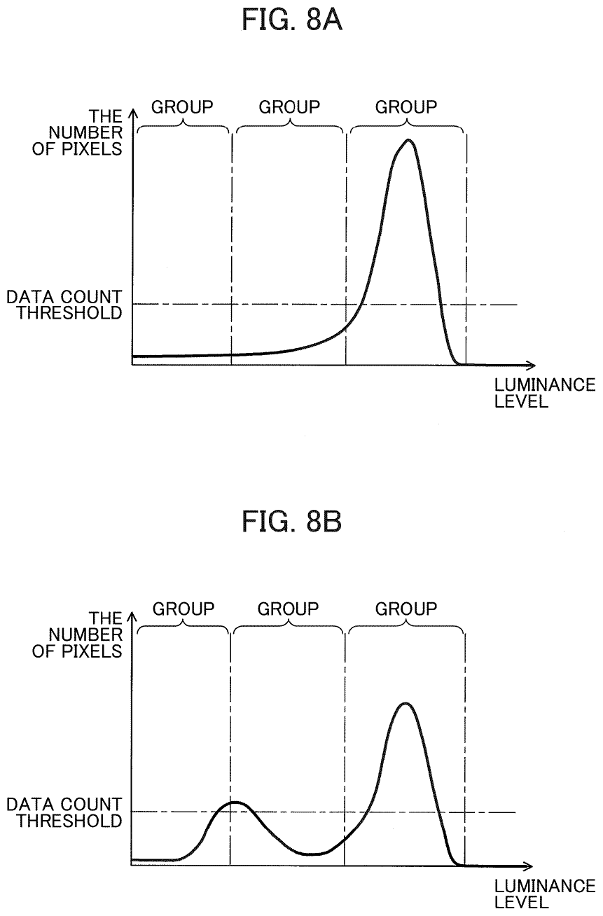

First, steps in a single-page determination process that uses a histogram for the entire page will be described with reference to the flowchart in FIG. 7. In S401 of this single-page determination process, the CPU 11 generates a histogram for the current page using luminance level as the class and the number of pixels as the frequency. In S402 the CPU 11 divides the histogram generated in S401 into a plurality of groups by a predetermined range of luminance levels (see FIGS. 8A and 8B). Each group has a corresponding range of luminance levels.

In S403 the CPU 11 determines for each group whether the group has any luminance level for which the number of pixels exceeds a predetermined data count threshold and obtains the number of groups having such luminance levels. FIGS. 8A and 8B show examples in which the CPU 11 has divided a histogram for one page into multiple groups for determining whether each group has a luminance value whose number of pixels exceeds the data count threshold. The data count threshold is an example of the threshold value.

In S404 the CPU 11 then determines whether the number of groups found to have luminance levels whose numbers of pixels exceed the data count threshold is just one. When the CPU 11 determines that the number of groups exceeding this predetermined data count threshold is just one (S404: YES), in S405 the CPU 11 determines that the current page is a blank page. A blank page has numerous pixels with luminance values close to the luminance value of the document's background color and few pixels with luminance values far from the background color. When the histogram has only one peak, as in the example of FIG. 8A, only one group with a number of pixels exceeding the data count threshold exists. Therefore, the CPU 11 determines that the current page is blank.

On the other hand, when the CPU 11 determines that the number of groups with luminance levels that exceed the data count threshold is not one (S404: NO), in S406 the CPU 11 determines that the current page is not blank. For example, when the histogram has two peaks, as shown in FIG. 8B, at least two groups with numbers of pixels exceeding the data count threshold exist. Therefore, the CPU 11 determines that the current page is not blank.

Following S405 or S406, the CPU 11 ends the single-page determination process and returns to the blank page extraction process. The single-page determination process shown in FIG. 7 is an example of the in-device determination process.

When using this single-page determination process in the blank page extraction process, in S221 of FIG. 3 the CPU 11 may transmit either the scan data or the histogram generated in S401 for the current page to the generative AI server 200.

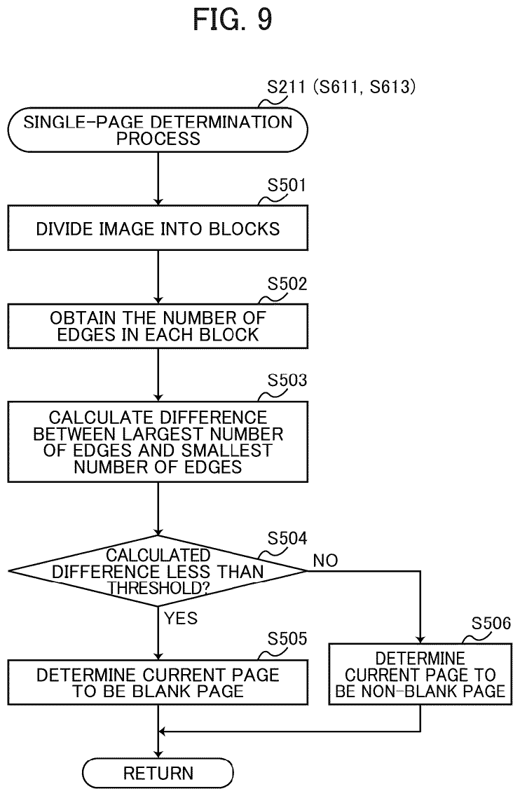

Next, steps in a single-page determination process using the number of edges in each block of a page will be described with reference to the flowchart in FIG. 9. The number of edges may refer to either the number of continuous edge regions (i.e., connected edge segments) or simply the number of pixels identified as edges (edge pixels), for example. In S501 of this single-page determination process, the CPU 11 divides a sheet image represented by the scan data for the current page into a plurality of blocks.

In S502 the CPU 11 detects edges in each block based on the difference in luminance values between each pixel and its neighboring pixel and obtains the number of detected edges. In S503 the CPU 11 further calculates the difference in the number of edges between the block with the largest number of edges and the block with the smallest number of edges. Specifically, the CPU 11 may identify the block having the largest number of edges among all the plurality of blocks and identify the block having the smallest number of edges among all the plurality of blocks, and calculates the difference between the largest number of edges and the smallest number of edges. Hereinafter, this calculated difference may be referred to as the maximum edge number difference. In S504 the CPU 11 determines whether the maximum edge number difference is less than a predetermined edge count threshold. The number of edges is an example of a detected number of edges. The edge count threshold is an example of the predetermined threshold value.

When the CPU 11 determines that the maximum edge number difference is smaller than the edge count threshold (S504: YES), in S505 the CPU 11 determines that the current page is a blank page. For example, when the number of edges is relatively high, but the edges are evenly distributed throughout the page, the document could be printed on paper having an uneven background, such as recycled paper. Because the maximum edge number difference is a maxim difference among differences calculated for all the combinations of two blocks selected from all the blocks where each difference is a difference in the number of edges between the selected two blocks, a YES determination in S504 indicates that all the differences are smaller than the edge count threshold.

On the other hand, when the CPU 11 determines that the maximum edge number difference exceeds the edge count threshold (S504: NO), in S506 the CPU 11 determines that the current page is not blank. Here, a NO determination in S504 indicates that at least one difference in the numbers of edge exceeds the edge count threshold. Following S505 or S506, the CPU 11 ends the single-page determination process and returns to the blank page extraction process shown in FIG. 3. The CPU 11 executes the blank page extraction process described above even when using this single-page determination process. The single-page determination process shown in FIG. 9 is an example of the in-device determination process.

As described above, the MFP 1 according to the first embodiment first scans a document and then transmits image information representing the scanning results for each page to the generative AI server 200, which uses a trained model 201. The trained model 201 can output determination information specifying whether the current page is blank. After receiving the determination information by the trained model 201 from the generative AI server 200, the MFP 1 excludes any page specified as blank in the determination information and performs output based on the scan data. Thus, it is very likely that the MFP 1 will obtain appropriate determination results for blank pages since the CPU 11 can expect more accurate determinations when using the trained model 201 than when relying only on the blank page determinations performed in the MFP 1.

Next, a second embodiment of a scanner according to the present disclosure will be described while referring to the accompanying drawings. As in the first embodiment, the MFP 1 according to the second embodiment executes the AI scanning process shown in the flowchart of FIG. 2 when an AI scan instruction is received. However, in the AI scanning process executed on the MFP 1 according to the second embodiment, the steps in the blank page extraction process of S111 differ from those in the first embodiment. In the following description, configurations and process steps identical to those in the first embodiment are designated with the same reference numerals and step numbers to avoid duplicating description.

In the second embodiment, the memory 12 includes a plurality of threshold sets 23.

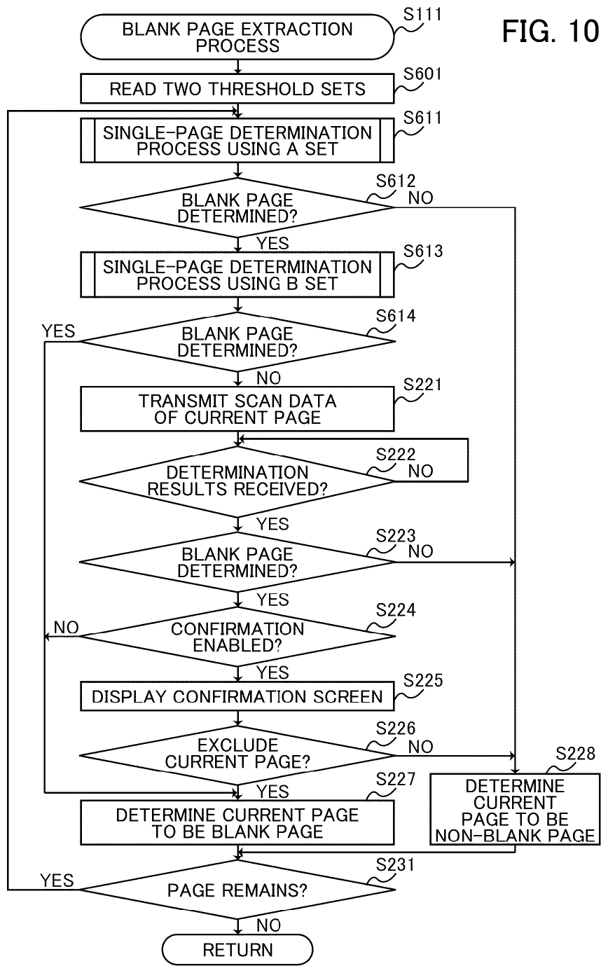

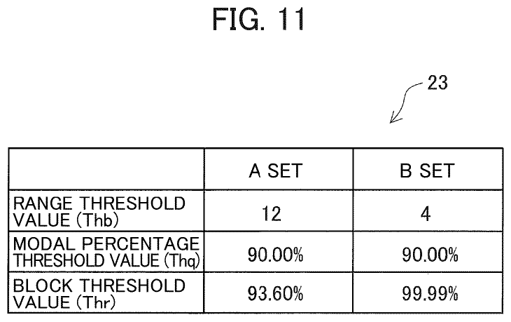

The blank page extraction process according to the second embodiment will be described with reference to the flowchart in FIG. 10. In S601 the CPU 11 reads two different types of threshold sets from the threshold sets 23 stored in the memory 12. As shown in FIG. 11, the plurality of threshold sets 23 stored in the memory 12 includes two types of threshold sets, an A set and a B set, each of which includes a combination of a range threshold value Thb, a modal percentage threshold value Thq, and a block threshold value Thr, for example. Each of the A set and B set is an example of the predetermined evaluation criterion. The A set and B set is in the memory 12 in advance as the threshold sets 23 to be used in the blank page extraction process.

Specifically, the A set in this example has a range threshold value Thb of 12, a modal percentage threshold value Thq of 90%, and a block threshold value Thr of 93.60%. The B set in this example has a range threshold value Thb of 4, a modal percentage threshold value Thq of 90%, and a block threshold value Thr of 99.99%. Hence, the range threshold value Thb in the B set is smaller than the range threshold value Thb in the A set. The smaller the range threshold value Thb, the narrower the specific range. Therefore, the specific range of the B set is narrower than the specific range of the A set. Further, the block threshold value Thr of the B set is larger than the block threshold value Thr of the A set. Each range threshold value Thb is a threshold value to identify the specific range. The range from class (M−Thb) to class (M+Thb) is an example of the specific range. The width of the range from class (M−Thb) to class (M+Thb) is an example of the specific width. The range threshold value Thb is used to determine the size or width of the specific range. Each block threshold value Thr is an example of the threshold value.

In S611 the CPU 11 executes a single-page determination process using the A set read in S601 as the threshold values. The single-page determination process of S611 is identical to the process shown in FIG. 4 except for the threshold set used. In S612 the CPU 11 then determines whether the current page has been determined to be blank in the single-page determination process of S611. The single-page determination process in S611 is an example of the first in-device determination process.

When the CPU 11 determines that the current page has been determined to be blank using the A set (S612: YES), in S613 the CPU 11 executes the single-page determination process using the B set read in S601 as the threshold values. The single-page determination process of S613 is identical to the process shown in FIG. 4 except for the parameter set used. In S614 the CPU 11 then determines whether the current page has been determined to be blank in the single-page determination process of S613. The single-page determination process in S613 is an example of the second in-device determination process.

As described above, the CPU 11 determines that a page is blank in the single-page determination process shown in FIG. 4 when the percentage of blank blocks in the page exceeds the block threshold value Thr, where each blank block is a block whose percentage of the total pixel number P (see FIGS. 5A and 5B) within the range of the range threshold value Thb from the mode M exceeds the modal percentage threshold value Thq. As described above, the block threshold value Thr in the B set is greater than the block threshold value Thr in the A set. Therefore, when the number of blank blocks on the page is between the block threshold value Thr of the B set and the block threshold value Thr of the A set, for example, the page will be determined to be a blank page in S611 using the A set but will be determined not to be a blank page in S613 using the B set.

Further, since the range threshold value Thb of the B set is smaller than the range threshold value Thb of the A set, the total pixel number P (see FIGS. 5A and 5B) according to the B set is smaller than the total pixel number P according to the A set for blocks having the same histogram. Hence, the number of blocks determined to be blank blocks is likely to be smaller when using the B set than when using the A set. The smaller the number of blank blocks on a page, the less likely the page will be determined to be blank.

In other words, the A set is more likely to result in a determination that a page is blank than the B set. That is, the B set is less likely to result in a determination that a page is blank than the A set. Thus, in S611 the CPU 11 executes the single-page determination process using criteria that is more likely to determine a page blank, and in S613 the CPU 11 executes the single-page determination process using criteria that is less likely to determine a page blank. The A set is an example of the first evaluation criterion and the B set is an example of the second evaluation criterion.

While the modal percentage threshold value Thq is set to the same value for the A set and B set in FIG. 11, the threshold sets are not limited to these values for the modal percentage threshold value Thq. For example, the modal percentage threshold value Thq in the B set may be a larger value than the modal percentage threshold value Thq in the A set. Setting the model threshold value Thq to a larger value increases the possibility that a block having the same total pixel number P will be judged not to be blank. In other words, a threshold set having a large modal percentage threshold value Thq is less likely to result in a blank page determination. The modal percentage threshold value Thq is an example of the threshold value.

When the CPU 11 determines that the current page is blank using the A set (S612: YES) but does not determine that the current page is blank using the B set (S614: NO), in S221 the CPU 11 uses the blank determination by the trained model 201 of the generative AI server 200 in the same manner as the first embodiment. The page for which a YES determination is made in S612 and a NO determination is made in S614 is an example of the specific page.

Specifically, when a determination result using the A set differs from the determination result using the B set, in S221 the CPU 11 transmits scan data of the current page to the generative AI server 200 and requests that the generative AI server 200 return information indicating the determination result by the trained model 201 as to whether the current page is blank. Once determination information is received from the generative AI server 200 (S222: YES), in S223 the CPU 11 determines whether the determination information contains a determination that the current page is blank.

When the CPU 11 determines that the information received from the generative AI server 200 indicates that a blank page has been identified (S223: YES), in S224 the CPU 11 determines whether confirmation setting is enabled. When the CPU 11 determines that the confirmation option is enabled (S224: YES), in S225 the CPU 11 displays the confirmation screen on the user interface 13 and accepts a user selection.

When the CPU 11 determines that a current page is blank while using the B set (S614: YES) or when the CPU 11 determines that the confirmation setting is not enabled (S224: NO) or when the CPU 11 determines that an instruction to exclude the current page has been received (S226: YES), in S227 the CPU 11 determines that the current page is a blank page. Since it is highly likely that the page is actually blank when the CPU 11 determines the current page is blank using the B set, the CPU 11 determines that the current page is a blank page without requesting a determination from the generative AI server 200.

On the other hand, when the CPU 11 determines that the current page is not blank using the A set (S612: NO) or when the CPU 11 determines that the determination information received from the generative AI server 200 contains a determination that the current page is not blank (S223: NO) or when the CPU 11 determines that an instruction not to exclude the current page has been received (S226: NO), in S228 the CPU 11 determines that the current page is a non-blank page. Since it is highly likely that the current page is actually not blank when the CPU 11 determines that the current page is not a blank page using the A set, the CPU 11 determines that the current page is a non-blank page without requesting a determination from the generative AI server 200.

Hence, when the determination results are split between the determination using the A set and the determination using the B set, the CPU 11 requests the generative AI server 200 to determine whether the current page is blank so as to make an appropriate determination. However, when the determination using the A set indicates that the current page is not blank or when the determination using the B set indicates that the current page is blank, the CPU 11 does not request the generative AI server 200 to perform a blank page determination, thereby reducing an increase in communication load.

After finalizing the blank page determination for all pages (S231: NO), the CPU 11 ends the blank page extraction process and returns to the AI scanning process. All steps in the AI scanning process other those in the blank page extraction process are identical to those in the first embodiment.

Rather than storing the A set and B set in the memory 12 in advance as the threshold sets 23 to be used in the blank page extraction process, the MFP 1 may be able to accept selections of the threshold sets to be used. In other words, when the MFP 1 receives an AI scan instruction, the MFP 1 may also accept operations to select threshold sets and may determine the combination of threshold sets based on the received operations. For example, the MFP 1 may store three or more sets as the threshold sets 23 and may accept selections of the threshold set to use in S611 and the threshold set to use in S613. Alternatively, the MFP 1 may accept a selection for either the threshold set to be used in S611 or the threshold set to be used in S613 through a user operation and may determine the other threshold set automatically based on the received selection. Alternatively, the CPU 11 may accept a selection of whether to use a combination of threshold sets that is more likely to yield a blank page determination or a combination of threshold sets that is less likely to yield a blank page determination and may set the combination of threshold sets based on the received selection (received criterion). Thus, by performing user operations to set the determination criterion for determining whether a page is blank with the MFP 1, the user can adjust the frequency at which the MFP 1 has the generative AI server 200 perform blank page determinations. The MFP 1 may present options for a first threshold set to be used in S611 and present options for a second threshold set to be used in S613 in such a manner that that the selected option for the second threshold set is less likely to result in a determination that a page is blank than the selected option for the first threshold set. For example, the MFP 1 may present options for the first threshold set for S611 and accept selection of one of the options, and thereafter present options for the second threshold set for S613 in such a manner that each option for the second threshold set is less likely to result in a determination that a page is blank than the selected option for the first threshold set.

Rather than executing a similar process to the single-page determination process of FIG. 4 in steps S611 and S613 of the blank page extraction process, the MFP 1 of the present embodiment may execute a process similar to the single-page determination process shown in FIG. 7 or may execute a process similar to the single-page determination process shown in FIG. 9.

When using the single-page determination process of FIG. 7, the MFP 1 according to the present embodiment may use two different data count thresholds in S611 and S613. For example, in S611 the CPU 11 uses a data count threshold that is more likely to yield a blank page determination even when the histogram contains two peaks, as shown in FIG. 8B of the first embodiment. Even when two peaks exist, the CPU 11 determines that the current page is blank in a case where one of the peaks is smaller than the data count threshold because only one group has a pixel count that exceeds the data count threshold.

In contrast, the CPU 11 uses a smaller data count threshold than the data count threshold for use in S611. For example, the CPU 11 uses a smaller data count threshold than that shown in FIGS. 8A and 8B. When using a small data count threshold to determine whether a page is blank, the number of groups having a pixel count that exceeds the data count threshold is more likely to be two or greater, even when one of the peaks is small. In other words, when using a small data count threshold to determine whether a page is blank, it is highly likely that the page will be determined to be not blank when the page has some areas of a color different from the background color.

Thus, the data count threshold used in S613 is smaller than the data count threshold used in S611 and is less likely to yield a determination that the current page is blank. The data count threshold for use in S611 is an example of a first evaluation criterion. The data count threshold for use in S613 is an example of a second evaluation criterion.

Even when using the single-page determination process in FIG. 7, when the CPU 11 determines that the current page is blank based on the determination result in S611 (S612: YES) but that the current page is not blank based on the determination in S613 (S614: NO), the CPU 11 sends the scan data for the current page to the generative AI server 200 and has the generative AI server 200 make a blank page determination. When the blank page determination results using the two different data count thresholds are split in this way, the CPU 11 requests the trained model 201 of the generative AI server 200 to make a blank page determination. Accordingly, the CPU 11 is likely to obtain appropriate determination results while reducing an increase in communication load.

When using the single-page determination process in FIG. 9, the MFP 1 uses two different edge count thresholds for the determinations in S611 and S613. In S611 the CPU 11 determines whether a page is blank using an edge count threshold that is more likely to yield a blank page determination. For example, the edge count threshold used in S611 is the same edge count threshold as in the first embodiment in this case. The CPU 11 determines that the current page is blank when the difference in the number of edges within blocks of the current page is smaller than the edge count threshold.

However, in S613 the CPU 11 uses a smaller edge count threshold than the edge count threshold used in S611. When the edge count threshold used in S611 is the same edge count threshold as in the first embodiment, the edge count threshold used in S613 is smaller than that used in the first embodiment. When determining whether a page is blank using a small edge count threshold, the difference in the number of edges within blocks of the page must be even smaller than in the case of S611, thereby yielding a determination indicating that the page is not blank.

The edge count threshold used in S613 is smaller than the edge count threshold used in S611 and is less likely to result in a determination that the current page is blank than the edge count threshold used in S611. The edge count threshold for use in S611 is an example of a first evaluation criterion. The edge count threshold for use in S613 is an example of a second evaluation criterion.

Even when using the single-page determination process in FIG. 9, when the CPU 11 determines that the current page is blank based on the determination of S611 (S612: YES) but determines that the current page is not blank based on the determination of S613 (S614: NO), the CPU 11 transmits scan data for the current page to the generative AI server 200 to have the generative AI server 200 determine whether the current page is blank. When determination results on whether a page is blank are split when using two different edge count thresholds in this way, the CPU 11 requests the trained model 201 of the generative AI server 200 to make a blank page determination. Accordingly, the CPU 11 is highly likely to obtain appropriate determination results while reducing an increase in communication load.

As described above, the MFP 1 according to the second embodiment can expect an accurate determination by the trained model 201 and is more likely to obtain appropriate determination results than in a case where the MFP 1 makes the blank page determination alone. Moreover, the number of times that the MFP 1 sends data to the generative AI server 200 in the second embodiment is fewer than in the first embodiment, reducing communication load. However, the first embodiment uses a simpler algorithm than the second embodiment.

While the disclosure has been described in conjunction with various example structures outlined above and illustrated in the figures, various alternatives, modifications, variations, improvements, and substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and or substantial equivalents. Some specific examples of potential alternatives, modifications, or variations in the described invention are described below: For example, the scanner is not limited to the MFP 1 but may be a copier, a fax machine, or any other device having an image reading function and a communication function.

While the MFP 1 attempts to make a blank page determination itself in both embodiments described above, the present invention is not limited to this configuration. That is, the MFP 1 may execute a scan and transmit the scan data generated for all pages to the generative AI server 200 without performing a blank page determination itself. In this case, the MFP 1 may send the scan data for one page at a time or may send scan data for all pages in the scanning results altogether.

In the above embodiments, the MFP 1 sends scan data for one page to the generative AI server 200 whenever the MFP 1 determines that scan data for the page is to be transmitted based on the result of a blank page determination on the MFP 1 itself. However, the MFP 1 may instead send scan data for all pages targeted for transmission to the generative AI server 200 together after the MFP 1 has completed blank page determinations for all pages in the document.

The information that the MFP 1 transmits to the generative AI server 200 is not limited to scan data but may be data the MFP 1 generates based on scan data. For example, the MFP 1 may transmit a histogram for each block of the page, a histogram for the entire page, or the number of edges in each block. Such information is likely to have a smaller data size than the scan data and therefore is likely to have a smaller communication load. However, when such information is transmitted, the algorithm the trained model 201 uses to determine blank pages may be similar to that used in the processes on the MFP 1.

In the above embodiments, the MFP 1 can accept a user confirmation in S224-S226 in the blank page extraction process (FIG. 3, etc.) when the trained model 201 of the generative AI server 200 determines that a page is blank, but the confirmation procedure may be omitted. Further, the confirmation screen shown in FIG. 6 is just one example, and the message and buttons displayed in the screen are not limited to the example in this drawing. Further, while the MFP 1 in the above embodiments can accept a setting to enable user confirmation, the MFP 1 may not accept a setting for the confirmation option. For example, the MFP 1 may simply perform output while excluding pages determined to be blank by the trained model 201.

In the second embodiment, the MFP 1 uses the A set and B set having mutually different block threshold values Thr and range threshold values Thb as the threshold sets in the single-page determination process, but the present invention is not limited to this configuration. The B set may differ from the A set in only the block threshold value Thr, only the range threshold value Thb, or only the modal percentage threshold value Thq, provided that the B set is less likely to yield a blank page determination than the A set. Additionally, the A set and B set may differ in two threshold values, one of which is the modal percentage threshold value Thq, among three threshold values, or may differ in all three threshold values. While the second embodiment illustrates the example in which the same threshold set used in the first embodiment as the A set, which has threshold values that are more likely to yield a blank page determination, these sets may not be the same.

The MFP 1 may also be capable of accepting an instruction to exclude blank pages when receiving a scan instruction through a user operation. The MFP 1 may execute the AI scanning process in the above embodiments when a scan instruction is received together with an instruction to exclude blank pages and may perform output based on all scan data without excluding blank pages when an instruction to exclude blank pages has not been received.

The MFP 1 may also be configured to accept an operation for an instruction to exclude blank pages via the user interface 13 or from an external device such as a personal computer or a smartphone and may store information indicating the received instruction (e.g., settings information) in the memory 12 prior to accepting an operation for a scan instruction. In this case, when the MFP 1 receives a scan instruction through a user operation, the MFP 1 may execute the AI scanning process when settings information specifying that blank pages are to be excluded is stored in the memory 12. Alternatively, the MFP 1 may be configured to execute the AI scanning process upon receiving a scan instruction through a user operation, without receiving an operation for an instruction to exclude blank pages.

An instruction to exclude blank pages may also include information indicating whether to exclude blank pages using the generative AI server 200 or to exclude blank pages without using the generative AI server 200. Here, the MFP 1 may execute the AI scanning process when an instruction to exclude blank pages using the generative AI server 200 has been received and may exclude blank pages without using the generative AI server 200 when an instruction to exclude blank pages without using the generative AI server 200 has been received. When excluding blank pages without using the generative AI server 200, the MFP 1 may determine that a page is blank when the page is determined to be blank in the single-page determination process (see FIG. 4). Specifically, with the MFP 1 according to the first embodiment, the CPU 11 may advance to S227 of the blank page extraction process (see FIG. 3) when reaching a YES determination in S212. With the MFP 1 of the second embodiment, the CPU 11 may advance to S227 of the blank page extraction process (see FIG. 10) when reaching a YES determination in S614. In this case, the CPU 11 may proceed to S228 when a NO determination is made in S614.

The generative AI server 200 is not limited to being a server that possesses the trained model 201 but may be capable of accessing the trained model 201 on another server. In such a case, the generative AI server 200 transfers various types of data, such as the scan data, received from the MFP 1 to the other server possessing the trained model 201 and sends response data to the MFP 1 based on the response received from this trained model 201.

Each of the above embodiments describes a configuration using the trained model 201 of the generative AI server 200, but the present disclosure may also be applied to a configuration using a program generated based on programming code by a programmer, instead of the trained model 201.

In any of the flowcharts or sequence diagrams disclosed in the embodiment, the plurality of processes included in any of a plurality of steps may be executed in parallel, or the order in which the processes are performed may be modified in any way that does not produce any inconsistencies in the processes.

The processes in the present disclosure are performed by a single CPU, a plurality of CPUs, hardware such as one or more Application Specific Integrated Circuits (ASICs), or any combination of these components. The disclosed processes are achieved through a computer-readable storage medium storing programs used to implement those processes or according to any methods or formats for performing those processes. The term “processor” encompasses both a single processor or a group of multiple processors located either locally or remotely working together or in a distributed fashion to collectively perform the tasks attributed to the “processor” described herein. One or more processors may be referred to as a controller.

Note that the present disclosure includes the phrases such as “at least one of A and B”, “at least one of A, B and C”, as alternative expressions that mean one or more of A and B, one or more of A, B and C, respectively. More specifically, the phrase “at least one of A and B” indicates (A), (B) or (A and B), and the phrase “at least one of A, B and C” indicates (A), (B), (C), (A and B), (A and C), (B and C) or (A, B and C).

What is claimed is:

1. A scanner comprising:
a scanning engine;
a user interface;
a communication interface; and
a controller including one or more processors, the controller being configured to perform:
a scan process under a scan start condition including a requirement that a scan instruction is received through the user interface, the scan process including:
reading an original using the scanning engine to generate first scan data, the original including a plurality of sheets, the first scan data for a plurality of page images each representing corresponding one or more sheets of the plurality of sheets;
a transmission process under a transmission condition, the transmission process including:
transmitting scan-related information to a server through the communication interface, the scan-related information being target page data in the first scan data or data based on the target page data, the target page data being page data for one or more first target page images of the plurality of page images;
a determination receiving process under a receiving condition including a requirement that the transmission process is completed, the determination receiving process including:
receiving determination information from the server via the communication interface, the determination information indicating that one or more second target page images of the one or more first target page images represent blank pages, the determination information being outputted by a trained machine learning model based on the scan-related information; and
a first outputting process under a first outputting condition, the first outputting condition including a requirement that the determination information is received from the server through the communication interface, the first outputting process including:
generating second scan data by excluding first blank page data from the first scan data based on the determination information, the first blank page data being page data for one or more removal page images of the one or more second target page images; and
outputting a first output object, the first output object being the second scan data or an object based on the second scan data.

2. The scanner according to claim 1,
wherein the controller is configured to further perform:
an in-device determination process under a condition including a requirement that the transmission process is not started, the in-device determination process including:
determining whether each of the plurality of page images represents a blank page,
wherein the transmission condition includes a requirement that a determination indicating that one of the plurality of page images represents a blank page is made in the in-device determination process,
wherein the transmission process is not performed under a condition including a requirement that a determination indicating that none of the plurality of page images represents a blank page is made in the in-device determination process,
wherein each of the one or more first target page images is a page determined to represent a blank page in the in-device determination process.

3. The scanner according to claim 2,
wherein the in-device determination process further includes:
dividing each of the plurality of page images into a plurality of blocks;
determining whether each of the plurality of blocks includes a non-blank image;
determining, when a blank block ratio of a blank block number to a total block number exceeds a first threshold value, that the each of the plurality of page images represents a blank page, the blank block number being the number of blocks determined not to include the non-blank image, the total block number being the number of the plurality of blocks; and
determining, when the blank block ratio does not exceed the first threshold value, that the each of the plurality of page images does not represent a blank page.

4. The scanner according to claim 2,
wherein the in-device determination process further includes:
dividing each of the plurality of page images into a plurality of blocks;
generating, for each of the plurality of blocks, a histogram in which each of a plurality of classes represents a corresponding one of a plurality of luminance levels and a frequency of the each of the plurality of classes corresponds to the number of pixels whose luminance values fall within the corresponding one of the plurality of luminance levels among pixels included in the each of the plurality of blocks;
determining, based on the histogram for the each of the plurality of blocks, when a pixel ratio of a specific pixel number to a total block-pixel number exceeds a first threshold value, that the each of the plurality of blocks does not include a non-blank image, the specific pixel number being the number of pixels whose luminance values fall within a specific range centered around a mode of the histogram for the each of the plurality of blocks among the pixels included in the each of the plurality of blocks, the total block-pixel number being the number of the pixels included in the each of the plurality of blocks;
determining, when the pixel ratio does not exceed the first threshold value, that the each of the plurality of blocks includes the non-blank image;
determining, when a blank block ratio of a blank block number to a total block number exceeds a second threshold value, that the each of the plurality of page images represents a blank page, the blank block number being the number of blocks determined not to include the non-blank image among the plurality of blocks, the total block number being the number of the plurality of blocks; and
determining, when the blank block ratio does not exceed the second threshold value, that the each of the plurality of page images does not represent a blank page.

5. The scanner according to claim 2,
wherein the in-device determination process further includes:
generating, for each of the plurality of page images, a histogram in which each of a plurality of classes represents a corresponding one of a plurality of luminance levels and a frequency of the each of the plurality of classes corresponds to the number of pixels whose luminance values fall within the corresponding one of the plurality of luminance levels among pixels included in the each of the plurality of page images;
classifying, based on the histogram for the each of the plurality of page images, each of the plurality of luminance levels into a plurality of groups based on luminance ranges;
determining, when the number of specific groups is not one, that the each of the plurality of page images does not represent a blank page, each of the specific groups being a group including a luminance level whose number of pixels exceeding a threshold value among the plurality of groups; and
determining, when the number of specific groups is just one, that the each of the plurality of page images represents a blank page.

6. The scanner according to claim 2,
wherein the in-device determination process further includes:
dividing each of the plurality of page images into a plurality of blocks;
identifying the number of edges included in each of the plurality of blocks;
determining, when a difference in the number of edges between any pair of the plurality of blocks exceeds a threshold value, that the each of the plurality of page images represents a non-blank page; and
determining, when no difference in the number of edges between any pair of the plurality of blocks exceeds the threshold value, that the each of the plurality of page images represents a blank page.

7. The scanner according to claim 1,
wherein the controller is configured to further perform:
a first in-device determination process under a condition including a requirement that the transmission process is not started, the first in-device determination process including
determining, based on a first evaluation criterion, whether each of the plurality of page images represents a blank page; and
a second in-device determination process under a condition including a requirement that the transmission process is not started, the second in-device determination process including:
determining, based on a second evaluation criterion, whether the each of the plurality of page images represents a blank page, the second evaluation criterion being less likely to result in a determination that a sheet image represents a blank page than the first evaluation criterion;
wherein the transmission condition includes a requirement that the determining in the first in-device determination process determines that one of the plurality of page images represents a blank page and the second in-device determination process determines that the one of the plurality of page images does not represent a blank page,
wherein each of the one or more first target page images is a page determined to represent a blank page in the first in-device determination process but determined not to represent a blank page in the second in-device determination process,
wherein the second scan data does not include page data for one or more page images determined to represent blank pages in the second in-device determination process.

8. The scanner according to claim 7,
wherein the first in-device determination process further includes:
dividing each of the plurality of page images into a plurality of blocks;
determining, based on a first sub-criterion, whether each of the plurality of blocks includes a non-blank image, the first sub-criterion being based on the first evaluation criterion;
determining, when a first blank block ratio of a first block number to a total block number exceeds a first threshold value, that the each of the plurality of page images represents a blank page, the first block number being the number of blocks determined not to include the non-blank image based on the first sub-criterion, the total block number being the number of the plurality of blocks, the first threshold value being based on the first evaluation criterion; and
determining, when the first blank block ratio does not exceed the first threshold value, that the each of the plurality of page images does not represent a blank page,
wherein the second in-device determination process further includes:
determining, based on a second sub-criterion, whether the each of the plurality of blocks includes a non-blank image, the second sub-criterion being based on the second evaluation criterion;
determining, when a second blank block ratio of a second block number to the total block number exceeds a second threshold value, that the each of the plurality of page images represents a blank page, the second block number being the number of blocks determined not to include the non-blank image based on the second sub-criterion, the second threshold value being based on the second evaluation criterion; and
determining, when the second blank block ratio does not exceed the second threshold value, that the each of the plurality of page images does not represent a blank page,
where the second threshold value is greater than the first threshold value.

9. The scanner according to claim 7,
wherein the first in-device determination process further includes:
dividing each of the plurality of page images into a plurality of blocks;
generating, for each of the plurality of blocks, a histogram in which each of a plurality of classes represents a corresponding one of a plurality of luminance levels and a frequency of the each of the plurality of classes corresponds to the number of pixels whose luminance values fall within the corresponding one of the plurality of luminance levels among pixels included in the each of the plurality of blocks;
determining, based on the histogram for the each of the plurality of blocks, when a first pixel ratio of a first pixel number to a total block-pixel number exceeds a first threshold value, that the each of the plurality of blocks does not include a non-blank image, the first pixel number being the number of pixels whose luminance values fall within a first specific range of a first width centered around a mode of the histogram for the each of the plurality of blocks among pixels included in the each of the plurality of blocks, the total block-pixel number being the number of the pixels included in the each of the plurality of blocks, the first threshold value and the first width being based on the first evaluation criterion;
determining, when the first pixel ratio does not exceed the first threshold value, that the each of the plurality of blocks includes the non-blank image;
determining, when a first blank block ratio of a first block number to a total block number exceeds a second threshold value, that the each of the plurality of page images represents a blank page, the first block number being the number of blocks determined not to include the non-blank image among the plurality of blocks in the determining using the first threshold value, the second threshold value being based on the first evaluation criterion; and
determining, when the first blank block ratio does not exceed the second threshold value, that the each of the plurality of page images does not represent a blank page,
wherein the second in-device determination process further includes:
determining, based on the histogram for the each of the plurality of blocks, when a second pixel ratio of a second pixel number to the total block-pixel number exceeds a third threshold value, that the each of the plurality of blocks does not include the non-blank image, the second pixel number being the number of pixels whose luminance values fall within a second specific range of a second width centered around the mode among the pixels included in the each of the plurality of blocks, the third threshold value and the second width being based on the second evaluation criterion;
determining, when the second pixel ratio does not exceed the third threshold value, that the each of the plurality of blocks does not include the non-blank image;
determining, when a second blank block ratio of a second block number to the total block number exceeds a fourth threshold value, that the each of the plurality of page images represents a blank page, the second block number being the number of blocks determined not to include the non-blank image among the plurality of blocks in the determining using the third threshold value, the fourth threshold value being based on the second evaluation criterion; and
determining, when the second blank block ratio does not exceed the fourth threshold value, that the each of the plurality of page images does not represent a blank page,
wherein the fourth threshold value is greater than the second threshold value,
wherein the second width is smaller than the first width.

10. The scanner according to claim 7,
wherein the first in-device determination process further includes:
dividing each of the plurality of page images into a plurality of blocks;
generating, for each of the plurality of blocks, a histogram in which each of a plurality of classes represents a corresponding one of a plurality of luminance levels and a frequency of the each of the plurality of classes corresponds to the number of pixels whose luminance values fall within the corresponding one of the plurality of luminance levels among pixels included in the each of the plurality of blocks;
determining, based on the histogram for the each of the plurality of blocks, when a first pixel ratio of a first pixel number to a total block-pixel number exceeds a first threshold value, that the each of the plurality of blocks does not include a non-blank image, the first pixel number being the number of pixels whose luminance values fall within a first specific range of a first width centered around a mode of the histogram for the each of the plurality of blocks among pixels included in the each of the plurality of blocks, the total block-pixel number being the number of the pixels included in the each of the plurality of blocks, the first threshold value and the first width being based on the first evaluation criterion;
determining, when the first pixel ratio does not exceed the first threshold value, that the each of the plurality of blocks includes the non-blank image;
determining, when a first blank block ratio of a first block number to a total block number exceeds a second threshold value, that the each of the plurality of page images represents a blank page, the first block number being the number of blocks determined not to include the non-blank image among the plurality of blocks in the determining using the first threshold value, the second threshold value being based on the first evaluation criterion; and
determining, when the first blank block ratio does not exceed the second threshold value, that the each of the plurality of page images does not represent a blank page,
wherein the second in-device determination process further includes:
determining, based on the histogram for the each of the plurality of blocks, when a second pixel ratio of a second pixel number to the total block-pixel number exceeds a third threshold value, that the each of the plurality of blocks does not include the non-blank image, the second pixel number being the number of pixels whose luminance values fall within a second specific range of a second width centered around the mode among the pixels included in the each of the plurality of blocks, the third threshold value and the second width being based on the second evaluation criterion;
determining, when the second pixel ratio does not exceed the third threshold value, that the each of the plurality of blocks does not include the non-blank image;
determining, when a second blank block ratio of a second block number to the total block number exceeds a fourth threshold value, that the each of the plurality of page images represents a blank page, the second block number being the number of blocks determined not to include the non-blank image among the plurality of blocks in the determining using the third threshold value, the fourth threshold value being based on the second evaluation criterion; and
determining, when the second blank block ratio does not exceed the fourth threshold value, that the each of the plurality of page images does not represent a blank page,
wherein the third threshold value is greater less than the first threshold value.

11. The scanner according to claim 7,
wherein the first in-device determination process further includes:
generating, for each of the plurality of page images, a histogram in which each of a plurality of classes represents a corresponding one of a plurality of luminance levels and a frequency of the each of the plurality of classes corresponds to the number of pixels whose luminance values fall within the corresponding one of the plurality of luminance levels among pixels included in the each of the plurality of page images;
classifying, based on the histogram for the each of the plurality of page images, each of the plurality of luminance levels into a plurality of groups based on luminance ranges;
determining, when the number of first specific groups is not one, that the each of the plurality of page images does not represent a blank page, each of the first specific groups being a group including a luminance level whose number of pixels exceeding a first threshold value among the plurality of groups, the first threshold value being based on the first evaluation criterion,
determining, when the number of the first specific groups is just one, that the each of the plurality of page images represents a blank page; and
wherein the second in-device determination process further includes:
determining, when the number of second specific groups is not one, that the each of the plurality of page images does not represent a blank page, each of the second specific groups being a group including a luminance level whose number of pixels exceeding a second threshold value among the plurality of groups, the second threshold value being based on the second evaluation criterion,
determining, when the number of the second specific groups is just one, that the each of the plurality of page images represents a blank page; and
wherein the second threshold value is less than the first threshold value.

12. The scanner according to claim 7,
wherein the first in-device determination process further includes:
dividing each of the plurality of page images into a plurality of blocks;
identifying the number of edges included in each of the plurality of blocks;
determining, when a difference in the number of edges between any pair of the plurality of blocks exceeds a first threshold value, that the each of the plurality of page images represents a blank page, the first threshold value being based on the first evaluation criterion; and
determining, when no difference in the number of edges between any pair of the plurality of blocks exceeds the first threshold value, that the each of the plurality of page images represents a non-blank page,
wherein the second in-device determination process further includes:
determining, when a difference in the number of edges between any pair of the plurality of blocks exceeds a second threshold value, that the each of the plurality of page images represents a non-blank page, the second threshold value being based on the second evaluation criterion; and
determining, when no difference in the number of edges between any pair of the plurality of blocks exceeds the second threshold value, that the each of the plurality of page images represents a blank page,
wherein the second threshold value is less than the first threshold value.

13. The scanner according to claim 7,
wherein the controller is configured to further perform:
a setting process including:
setting at least one of the first evaluation criterion or the second evaluation criterion based on an operation received through the user interface.

14. The scanner according to claim 1,
wherein the controller is configured to further perform:
a confirmation process under a confirmation condition including a requirement that the determination information is received from the server via the communication interface, the confirmation process including:
receiving, based on an operation through the user interface, a selection indicating whether to accept each of the one or more second target page images indicated as an image representing a blank page in the determination information,
wherein each of the one or more removal page images is a page accepted as a blank page in the confirmation process.

15. The scanner according to claim 14, further comprising:
a memory,
wherein the confirmation condition further includes a requirement that the memory stores a setting indicating that the confirmation process is enabled,
wherein the confirmation process is not performed under a condition that the memory stores a setting indicating that the confirmation process is disabled,
wherein the first outputting condition further includes a requirement that the confirmation process is completed,
wherein the controller is configured to further perform:
a second outputting process under a second outputting condition, the second outputting condition including a requirement that the determination information is received from the server through the communication interface and a requirement that the memory stores a setting indicating that the confirmation process is disabled, the second outputting process including:
generating third scan data by excluding second blank page data from the first scan data based on the determination information, the second blank page data being page data for all the one or more second target page images; and
outputting a second output object, the second output object being the third scan data or an object based on the third scan data.

16. The scanner according to claim 1,
wherein the first outputting process is performed without receiving confirmation through the user interface,
wherein the one or more removal page images are all the one or more second target page images.

17. The scanner according to claim 1,
a storage location receiving process including:
receiving location information indicating a storage location through the user interface,
wherein the outputting in the first outputting process includes:
storing, as the first output object, the second scan data or image data in the storage location indicated in the location information, the image data being based on the second scan data.

18. The scanner according to claim 17,
wherein the controller is configured to further perform:
a format receiving process including:
receiving format information indicating a file format through the user interface,
wherein the outputting in the first outputting process includes:
converting the second scan data into the image data in the file format indicated in the format information.

19. The scanner according to claim 1, further comprising:
a printing engine,
wherein the outputting in the first outputting process includes:
printing, as the first output object, an image on a sheet based on the second scan data using the printing engine.
